(19) United States
(12) Patent Application Publication
(10) Pub. No.: US 2002/0159155 A1
(43) Pub. Date: Oct. 31, 2002

(54) Laser protective eyewear

(75) Inventor: Joseph O'Brien, Saint Paul, MN (US)

Correspondence Address: NIKOLAI & MERSEREAU, P.A., 900 SECOND AVENUE SOUTH, SUITE 820, MINNEAPOLIS, MN, 55402, US

(73) Assignee: Trinity Technologies, Minneapolis, MN (US)

(21) Appl. No.: 09/845,366

(22) Filed: Apr. 30, 2001

(51) Int. Cl. G02B 27/00; G02B 5/08; G02B 17/00

(52) U.S. Cl. 359/614; 359/601; 359/608

(57) ABSTRACT

Protective eyewear for blocking laser light from entering the eyes of the wearer. The eyewear having a light absorbing filter and an adjacent light-reflecting filter such that laser light will first be reflected by the reflecting layer and then absorbed by the absorbing layer. If the light-reflecting filter is damaged or scratched the light not reflected would be absorbed by the light-absorbing filter. Similarly if the angle of incidence is such that the light-reflecting filter does not reflect the incident light the light-absorbing filter will absorb the light. The light-reflecting filter reflects a majority of the incident light on the protective eyewear and thus protects the light-absorbing filter from reaching its damage threshold. The combination of light absorbing and light reflecting filters provides better protection against light penetration of a specified wavelength than either type of filter working along.

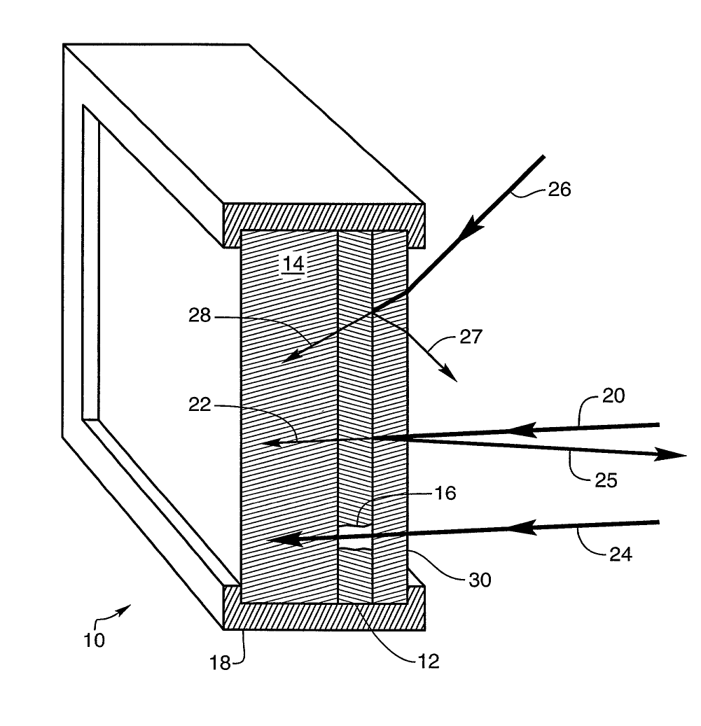

### BACKGROUND OF THE INVENTION

1. Field of the Invention

This invention relates to protective eyewear for use with lasers and more particularly an eyepiece with reflective and absorptive layers for reflecting and absorbing the same wavelength.

2. Description of the Related Art

When working with or around lasers it is desired to wear protective eyewear to prevent injury the eyes of a worker.

For many applications it is desired to block only the wavelength of the laser and not other visible wavelengths such that the workers can see to perform their jobs while wearing the protective eyewear. Therefore the eyewear should reflect or absorb only a small band of wavelengths in the band of the laser light so that the worker can see all other visible wavelengths unimpaired.

Absorptive eye protection with dyes imbedded in a glass, plastic or polymer have damage threshold limits. If the threshold limits are exceeded the ability of the filter to protect the eyes of the user may be reduced or eliminated. The heat from absorbing large amounts of energy may damage the filters. The damage may be in the form of shattering or cracking of the glass the dye is embedded in. Damage may also be in the form of melting or distorting the plastic or polymer the dye is embedded in.

Absorptive filters are relatively thick and heavy compared to reflective filters. Further, absorptive filters typically block a wide spectrum of light rather than a narrowly selected band.

Reflective filters are very thin layers of dialectic materials deposited on substrates. The reflective coating is angle of incidence sensitive. Further if the reflective coating is scratched or otherwise damaged laser light will pass through that portion of the reflective filter.

Filters have been used where multiple wavelengths of laser light are filtered. One laser wavelength is filtered with a reflective layer and one wavelength is filtered with an absorptive layer. However, no prior eyewear provides a double layer of protection for the same wavelength wherein the advantages of the absorptive filter and the reflective filter are combined to provide greater protection to the wearer.

### SUMMARY OF THE INVENTION

The laser protective eyewear utilizes a reflective filter outer layer deposited on an absorptive filter substrate to protect the eyes of a person who may be exposed to laser radiation. The reflective outer layer reflects a large portion of the laser. If the reflective outer layer is scratched or otherwise damaged, or the laser is incident at a high angle the absorptive substrate will absorb the laser light that passes through the reflective layer providing a double layer of protection to the wearer. The energy of the light incident on the absorptive layer should be lower than the damage threshold since it has to pass through the reflective layer to reach the absorptive layer. The absorptive layer is not angle sensitive and will protect the wearer no matter what the angle of incidence of the laser beam is.

The advantages of reflecting and absorptive filter are provided to the wearer while protecting the wearer from the disadvantages of both types of filters. The combination of the light reflecting and light absorbing filters provide a better protection than either filter working alone.

### OBJECTS OF THE INVENTION

It is an object of the invention to filter out laser light at any angle of incidence.

It is an object of the invention to provide high optical density filters, which perform well even if the reflective layer is scratched.

It is an object of the invention to reflect a large portion of the laser to protect the absorptive filter from reaching its damage threshold.

It is an object of the invention to provide improved eye protection by eliminating the disadvantages of light absorbing filters and light reflecting filters when used separately.

It is an object of the invention to provide improved eye protection by combing the advantages of light absorbing filters and light reflecting filters in one eye-protecting filter.

Other objects, advantages and novel features of the present invention will become apparent from the following detailed description of the invention when considered in conjunction with the accompanying drawing.

### BRIEF DESCRIPTION OF THE DRAWINGS

The FIGURE is a cross sectional view of a combination reflective and absorptive filter.

### DESCRIPTION OF THE PREFERRED EMBODIMENTS

The figure shows a light filter 10 used in protective eyewear. The light filter 10 is held in place by frame 18, such as glasses frames, to secure the filter in front of the eyes of a wearer. The light filter 10 has a light-absorbing filter 14 which is preferably a glass or polymer with a dye embedded therein for absorbing light wavelengths which are tuned to the dye. The light filter 10 also has a light-reflecting filter 12 on its outer surface. The light-reflecting filter 12 is preferably a thin film of a dielectric material vacuum deposited onto the light-absorbing filter 14.

Light-absorbing filters have dyes embedded therein tuned to absorb specified wavelengths of light. One of the disadvantages of light-absorbing filters is that the light they absorb heats them and they have a damage threshold, which should not be exceeded. If the glass or polymer is heated too much the glass can crack or shatter and the polymer can melt or warp. With the filter damaged laser light can penetrate to the eye. Further the heat next to the eyes of a worker is deleterious and if the glass or polymer shatters or breaks the wearer can be injured. To protect the light-absorbing filter 14 a light-reflecting filter 12 on the outside surface of the light-absorbing filter 14 will reflect a large portion 25 of the incident laser light 20 preventing the light-absorbing filter 14 from being heated too much. Although the light-reflecting filter 12 may have a large optical density some laser light 22 will penetrate the light-reflecting filter 12 and be absorbed by the light-absorbing filter 14 thus providing a double layer of protection for the wearer.

The reflective outer filter 12 being vacuum deposited in a thin layer is subject to scratches 16 or other damage, which can compromise the effectiveness of its reflection of incident light such as laser light 24 which can pass thought the scratched portion of the reflective outer surface 12 and reach the light absorbing filter 14. The light-absorbing filter 14 can absorb the small amount of laser light passing though the scratch 16 without reaching its damage threshold thus protecting the wearer from eye damage. In a preferred embodiment a protective coating 30 deposited on the outside of the light-reflecting filter 12 will help prevent it from being damaged.

Although a light-reflecting filter 12 made of a dielectric material is highly reflective for a small bandwidth of light normally incident thereon, such as laser beam 20 being largely reflected as laser beam 25, and transmitting only a small portion as laser beam 22, it is not as effective at reflecting the same wavelength of light at large angles of incidence such as laser beam 26 having a small reflected component 27 and large transmitted component 28. When laser light 26 is incident at a large angle the transmitted portion 28 will be absorbed by the light-absorbing filter 14 thus providing protection to the wearer.

Since the light-absorbing filter 14 is heavier than the light-reflecting filter 12 it is preferred to have as small a light-absorbing filter 14 portion as possible and still provide the level of protection needed to back up the light-reflecting filter 12. When both the light-reflecting filter 12 and the light-absorbing filter 14 are tuned to block the laser of a particular wavelength the wearer has a double layer of protection from the laser. In this manner if the light-reflecting layer is damaged or if the laser is incident on the filter 10 at a large angle the wearer is still protected from eye damage. The light-reflecting filter 12 generally reflects a large portion of the laser light and prevents the light-absorbing filter 14 from reaching its damage threshold which could then damage the wearer by allowing laser light into the eye.

With the light-reflecting filter tuned to a narrow band around the laser light to be reflected and the light-absorbing filter tuned to a wider band around the laser light to be absorbed the wearer is doubly protected and the advantages of both types of filters work to cover the disadvantages of the other type for maximizing the protection of the wearer.

Obviously, many modifications and variations of the present invention are possible in light of the above teachings. It is therefore to be understood that, within the scope of the appended claims, the invention may be practiced otherwise than as specifically described.

What is claimed is:

1. A laser protective eyewear filter comprising:
a light absorbing filter, selected to absorb the wavelength of a laser beam, and
a light reflecting filter, selected to reflect the wavelength of the laser beam, the light reflecting filter placed in front of the light absorbing filter, to reflect the laser before it reaches the light absorbing filter, such that only a small portion of the laser beam passes through the combination of the light absorbing filter and the light reflecting filter.

2. A laser protective eyewear filter as in claim 1 wherein,
the light reflecting filter is a dielectric material on the surface of the light absorbing filter.

3. A laser protective eyewear filter as in claim 1 wherein,
the light absorbing filter is glass with a dye imbedded therein.

4. A laser protective eyewear filter as in claim 1 wherein,
the light absorbing filter is polymer with a dye imbedded therein.

5. A laser protective eyewear filter as in claim 3 wherein,
the light reflecting filter is a dielectric material on the surface of the light absorbing filter.

6. A laser protective eyewear filter as in claim 4 wherein,
the light reflecting filter is a dielectric material on the surface of the light absorbing filter.
